(19) United States
(12) Patent Application Publication
(10) Pub. No.: US 2009/0319100 A1
(43) Pub. Date: Dec. 24, 2009

(54) SYSTEMS AND METHODS FOR DEFINING AND RENDERING A TRAJECTORY

(75) Inventors: Nitin Anand Kale, Bangalore (IN); Keshav Rao, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/143,491

(22) Filed: Jun. 20, 2008

(51) Int. Cl. G05D 1/10

(52) U.S. Cl. 701/4

(57) ABSTRACT

Embodiments of systems and methods for defining and rendering a trajectory of an aircraft include a processing system that causes a three dimensional trajectory depiction to be rendered on a display device. The trajectory depiction includes at least one trajectory element indicator that corresponds to at least one trajectory element of a flight plan. The processing system also receives one or more user interface commands that indicate selection by a user of a selected trajectory element indicator and user-initiated movement of the selected trajectory element indicator from a first display position to a second display position. The processing system determines one or more modified characteristics of a trajectory element corresponding to the selected trajectory element indicator in response to the user-initiated movement, and causes a modified trajectory depiction to be rendered. The modified trajectory depiction includes the selected trajectory element indicator rendered at the second display position.

### TECHNICAL FIELD

The embodiments generally relate to systems and methods for defining and rendering a trajectory, and more particularly relate to systems and methods for defining and rendering a trajectory of an aircraft.

### BACKGROUND

In an aircraft, an on-board flight management system (FMS) is adapted to assist the flight deck crew (referred to generally as “users”) in performing navigation, flight planning, and aircraft control functions. Current FMS may include an FMS computer coupled to a user interface sub-system. The FMS computer may perform actual lateral, actual vertical (or altitude), and/or predicted flight path computations based on the aircraft's current lateral position (e.g., latitude and longitude), current altitude, current operational state, and a computer-readable version of a pre-defined flight plan that is accessible to the FMS computer, among other things. The user interface sub-system may include one or more output devices (e.g., display devices, warning lights, and indicators) and user interface devices (e.g., cursor control devices, joysticks, keys, and/or keyboards). Among other things, the output devices may render the flight path and flight plan data, and the user interface devices may enable a user to input modifications to the flight plan and/or to the aircraft's trajectory. These modifications may be incorporated by the FMS computer into the flight plan, and the modified flight plan and/or the modified trajectory may be implemented by the FMS.

Current systems are adapted to render, in a graphical format, either a two-dimensional or a three-dimensional display of then-current lateral, vertical, and predicted flight path information. In a two-dimensional display system, the flight path may be rendered using a two-dimensional lateral flight path display and a separate two-dimensional vertical flight path display. In contrast, other systems may render a three-dimensional depiction of the flight path, which may be constructed from a two-dimensional lateral map combined with a two-dimensional vertical map. When compared with traditional systems in which flight path information is displayed only in two dimensions, these three-dimensional displays may provide for increased situational awareness, because a three-dimensional depiction of the flight path may be more readily interpreted by a user.

Although flight path information displayed in three dimensions may be more intuitively comprehensible manner than previous, two-dimensional displays, the efficiency and user-friendliness of flight plan entry and editing for such three-dimensional systems may be improved. Accordingly, it is desirable to provide improved user interfaces for flight planning and trajectory editing in systems in which flight path information is displayed in three dimensions. Other desirable features and characteristics of the embodiments will become apparent from the subsequent detailed description of the inventive subject matter and the appended claims, taken in conjunction with the accompanying drawings and this background of the inventive subject matter.

### BRIEF SUMMARY

An embodiment of a system for defining and rendering a trajectory of an aircraft includes a processing system adapted to cause a three dimensional trajectory depiction to be rendered on a display device. The three dimensional trajectory depiction includes at least one trajectory element indicator that corresponds to at least one trajectory element of a flight plan. The processing system is further adapted to receive, from a user interface device, one or more user interface commands that indicate selection by a user of a selected trajectory element indicator and user-initiated movement of the selected trajectory element indicator from a first display position to a second display position. The processing system is further adapted to determine one or more modified characteristics of a trajectory element corresponding to the selected trajectory element indicator in response to the user-initiated movement, and to cause a modified trajectory depiction to be rendered. The modified trajectory depiction includes the selected trajectory element indicator rendered at the second display position.

Another embodiment includes a method for defining and rendering a trajectory of an aircraft. The method includes causing a three dimensional trajectory depiction to be rendered on a display device. The three dimensional trajectory depiction includes one or more trajectory element indicators that correspond to one or more trajectory elements of a flight plan. The method also includes receiving one or more user input commands from a user interface device. The one or more user input commands indicate selection by a user of a selected trajectory element indicator of the one or more trajectory element indicators, and a user-initiated movement of the selected trajectory element indicator from a first display position to a second display position. The method also includes determining one or more modified characteristics of a trajectory element corresponding to the selected trajectory element indicator in response to the user-initiated movement, and causing a modified trajectory depiction to be rendered on the display device. The modified trajectory depiction includes the selected trajectory element indicator rendered at the second display position.

### BRIEF DESCRIPTION OF THE DRAWINGS

The embodiments will hereinafter be described in conjunction with the following drawing figures, wherein like numerals denote like elements, and

FIG. 1 is a simplified block diagram of an electronic flight instrument system communicatively coupled to a flight management system, according to an example embodiment;

FIG. 2 is an example of a display screen within which a three dimensional trajectory depiction is rendered, according to an example embodiment;

FIG. 3 is an example of a display screen within which a lateral trajectory depiction is rendered, according to an example embodiment;

FIG. 4 is an example of a display screen within which a vertical trajectory depiction is rendered, according to an example embodiment;

FIG. 5 is an example of a display screen within which a smoothed, three dimensional trajectory depiction is rendered, according to an example embodiment;

FIG. 6 is a simplified, functional block diagram of a flight plan processing architecture, according to an embodiment; and

FIG. 7 is a flowchart of a method for defining and rendering a trajectory of an aircraft, according to an example embodiment.

### DETAILED DESCRIPTION

The following detailed description is merely representative in nature and is not intended to limit the inventive subject matter or the application and uses of the inventive subject matter. Furthermore, there is no intention to be bound by any theory presented in the preceding background or the following detailed description.

Embodiments include methods and apparatus for defining and rendering an aircraft trajectory. As used herein, the term “defining” as it relates to an aircraft trajectory, means initially defining characteristics of a new flight plan and/or modifying characteristics of an existing flight plan. Various embodiments include methods and apparatus for enabling a user to define a flight plan (e.g., a planned trajectory of an aircraft for an upcoming flight or portion of a flight) and/or for enabling a user to modify an existing flight plan through interaction with a three-dimensional display. In addition, various embodiments include methods and apparatus for displaying a flight plan and displaying previously flown portions of the flight plan (e.g., the flight path) during the flight. Although embodiments of the inventive subject matter may be described herein as pertaining to electronic flight instrument systems (EFIS) and methods implemented in an aircraft environment, it should be appreciated that embodiments of the systems and methods described herein alternatively could be applied in other environments or vehicles in which a user interface is designed to visually convey previous, current, predicted, and/or simulated flight path information, including vehicle positions, modes, targets, attitudes, altitudes and/or other information. Such other environments or vehicles may include, but are not limited to, general purpose computer systems (e.g., desktop computers and laptop computers), computer systems at ground control stations or other facilities, and simulators, to name a few. In addition, although embodiments of the inventive subject matter may be described herein as being implemented in the context of flight planning and/or flight control systems and methods, embodiments also could be applied in the context of flight simulation and/or other types of systems or methods.

The term “flight plan” means a set of information describing a flight. A flight plan may be defined by a plurality of “trajectory elements,” such as a departure point (or airport), a planned arrival point (or airport), one or more alternative arrival points (or airports), one or more waypoints, one or more trajectory segments, trajectory segment definitions (e.g., altitudes and airspeeds), estimated en-route times (e.g., estimated total enroute time and/or estimated trajectory segment en-route times), and/or other information relating to a flight, for example. Trajectory elements may be graphically depicted, in an embodiment, using “trajectory element indicators.” As used herein, the term “waypoint” means a trajectory element that defines a point in space along a trajectory. For example, a departure point, an arrival point, and one or more points between them may be considered waypoints. A waypoint may be defined and/or characterized, for example but not by way of limitation, by a VOR (Very high frequency (VHF) Omni-directional Radio range) beacon and/or its identifier, an NDB (non-directional beacon) and/or its identifier, a GPS (Global Positioning System) point, and/or another definition of a point on the ground or in space (e.g., indicated by altitude, latitude, and longitude or other coordinates). The term “trajectory segment” (or “segment”) may be defined as a trajectory element that defines a path between two waypoints. A trajectory segment may be defined, for example, by two endpoints (e.g., two consecutive waypoints), an airspeed, an altitude, and/or a line or curve between two endpoints.

The term “trajectory” means the path an aircraft follows through space between a departure point and an arrival point. The term “trajectory” may be used synonymously herein with the term “flight path”. A “flight plan” or “planned trajectory” may include, for example, all or portions of a flight plan, and accordingly a planned trajectory may be defined using trajectory elements. A “flight path” or “actual trajectory” may include, for example, all or portions of a flight path previously followed by an aircraft, which may deviate slightly or substantially from the corresponding flight plan. As with a planned trajectory, an actual trajectory may be defined using trajectory elements. When an aircraft is en-route between a departure point and an arrival point, the portion of the flight that has already occurred may be represented as an actual trajectory, and the portion of the flight that has not yet occurred may be represented as a planned trajectory. In addition, a “current segment” refers to a trajectory segment that the aircraft currently is following.

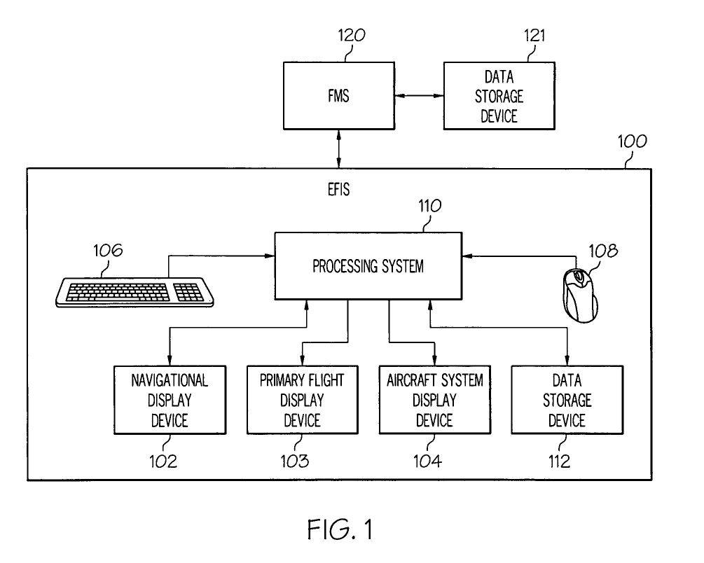

FIG. 1 is a block diagram of an electronic flight instrument system (EFIS) 100 communicatively coupled to a flight management system (FMS) 120, according to an example embodiment. In an embodiment, EFIS 100 is an aircraft subsystem that is adapted to provide an interface between a pilot and FMS 120. Both EFIS 100 and FMS 120 may be integrated into an avionics system of an aircraft.

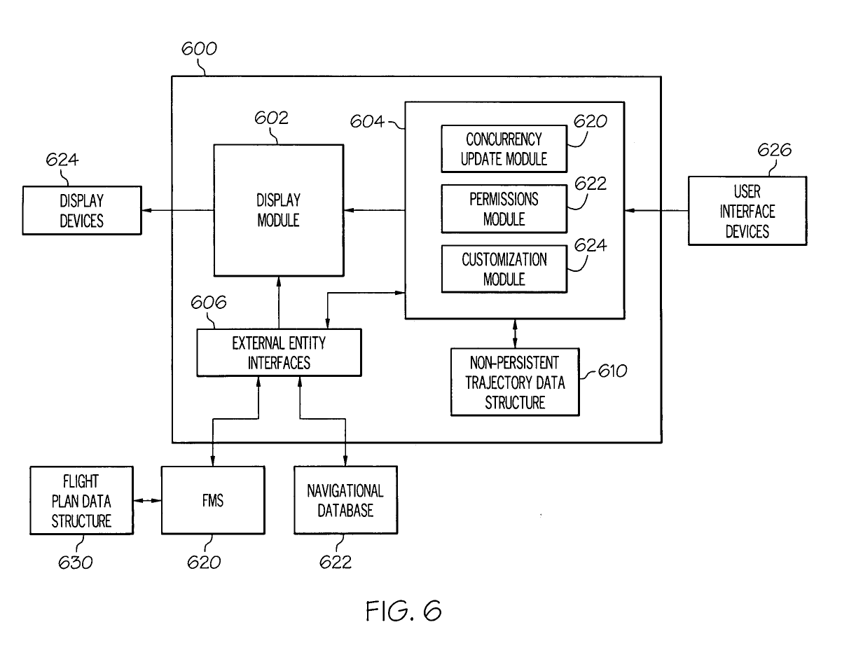

In an embodiment, FMS 120 is adapted to perform lateral, vertical (e.g., altitude), and/or predicted flight path computations based on the aircraft's current lateral position (e.g., latitude and longitude), current altitude, current operational state, and a computer-readable version of a pre-defined flight plan that is accessible to FMS 120. The pre-defined flight plan may be stored, for example, in a flight plan data structure (e.g., flight plan data structure 630, FIG. 6) within a data storage device 121 that is accessible to FMS 120. In addition, FMS 120 may generate and evaluate navigational information, and may execute auto pilot and/or autothrottle processes based on the flight plan and the navigational information, among other things. In addition, FMS 120 may be adapted to exchange information (e.g., commands and/or navigational information) with EFIS 100, in order to enable EFIS 100 to display a representation of a flight plan and/or a flight path of the aircraft. EFIS 100 is adapted to receive the information from FMS 120, and to display flight information (e.g., commands, real-time attitude, heading, position, planned route, and trajectory, among other things).

In an embodiment, EFIS 100 may operate in a flight path/flight plan display mode and a flight plan editing mode. In the flight path/flight plan display mode, EFIS 100 may display a trajectory in two or three dimensions. In the flight plan editing mode, EFIS. 100 also may display a trajectory in two or three dimensions, and may further facilitate flight plan generation and/or flight plan modification, according to various embodiments. As will be described in more detail later, EFIS 100 may be further adapted to send flight plan related requests to FMS 120, which convey information relating to newly-generated flight plans and/or modifications to flight plans. FMS 120 may evaluate the requests and may determine whether or not to incorporate information reflected into the requests into a flight plan based on flight plan constraints (e.g., rules) and/or strategies. Accordingly, in an embodiment, EFIS 100 may function as a front-end user interface for flight plan generation and/or modification processes, whereas FMS 120 may function as a back-end controller for storing, editing, and implementing flight plans that are maintained within a flight plan data structure.

EFIS 100 includes at least one display device 102, 103, 104, a keyboard 106, a cursor control device 108, at least one processing system 110, and at least one data storage device 112. Although particular numbers of each of these system components are illustrated in FIG. 1 and referred to below, it is to be understood that more or fewer of various ones of the components may be included within a system. EFIS 100 may be implemented in an aircraft environment or within another type of environment, as mentioned previously. In a particular embodiment, display devices 102-104, keyboard 106, and cursor control device 108 may be located within an aircraft flight deck, and processing system 110 and data storage device 112 may be located in proximity to the flight deck or elsewhere within the aircraft.

Any one or more of display devices 102-104 may include, for example but not by way of limitation, a liquid crystal display (LCD), a cathode ray tube (CRT), and/or another type of display. Each of display devices 102-104 receives signals, information, and/or data (referred to herein as “display commands”) from processing system 110, which indicate the content and positioning of displayed information. Display screens rendered on display devices 102-104 may be viewed by one or more flight deck crew (e.g., a pilot, copilot and/or navigator). In an embodiment, display devices 102-104 include a navigational display device 102, a primary flight display device 103, and an aircraft system display device 104. Although the description below discusses various information that may be displayed on each of display devices 102-104, it is to be understood that the examples of displayed information may be displayed on other ones of display devices 102-104 than indicated below. In addition, more or fewer display devices 102-104 may be included within the system to display the various types of aircraft information.

Primary flight display device 103 is adapted to receive display commands from processing system 110 that cause primary flight display device 103 to display some or all information essential to a flight, including but not limited to altitude, attitude, heading, airspeed, vertical speed, and yaw, for example. Accordingly, primary flight display device 103 may be used to display an integrated view of the information that may otherwise be represented using separate analog instruments. In contrast, aircraft system display device 104 is adapted to receive display commands from processing system 110 that cause aircraft system display device 104 to display information about various aircraft systems, including but not limited to the propulsion system (e.g., the engines), the electrical system, and the fuel system, among other things. Aircraft system display device 104 and/or primary flight display device 103 also may be used to provide flight crew alerts when unusual or hazardous conditions are sensed (e.g., low fuel, low oil pressure, low air speed, and so on).

Navigational display device 102 is adapted to receive display commands from processing system 110 that cause navigational display device 102 to display a graphical, three-dimensional (3D) depiction of a flight plan and/or an aircraft trajectory, in an embodiment. As will be described in more detail below, navigational display device 102 may include a touchscreen, and accordingly, is adapted to receive user inputs consisting of the application of pressure to various points on the surface of navigational display device 102. These user inputs may be represented as signals, information, and/or data (referred to herein as “user interface commands”) that are sent to and evaluated by processing system 110, in an embodiment. In such an embodiment, the navigational display device 102 may be considered a user interface device. In a particular embodiment, navigational display device 102 may graphically represent a flight plan and/or an aircraft trajectory in three-dimensions as a collection of displayed trajectory elements (e.g., a departure point, a planned arrival point, one or more alternative arrival points, one or more waypoints, one or more trajectory segments, and other information).

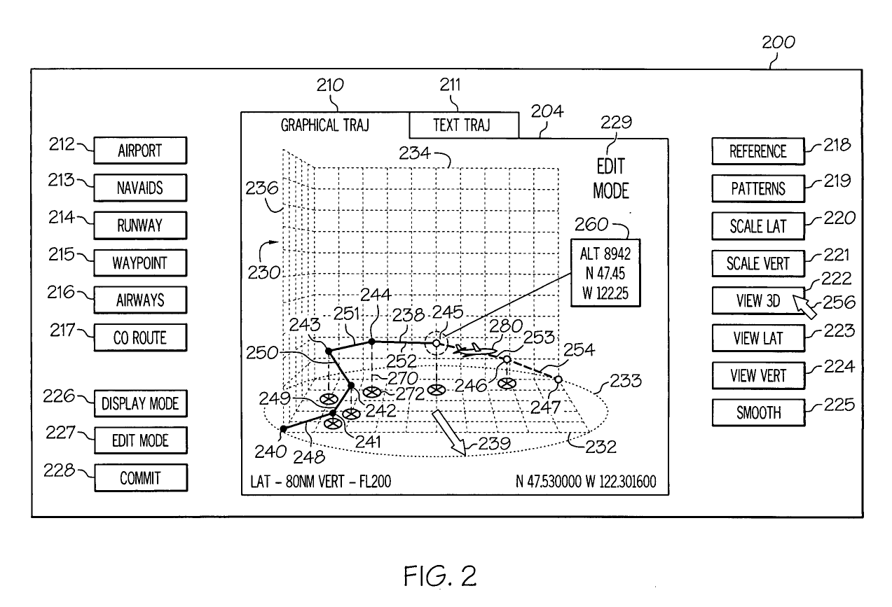

A user may indicate a selection of a particular displayed trajectory element by applying pressure to a portion of the surface of the navigational display device's touchscreen at which the trajectory element indicator is displayed, in an embodiment. In addition or alternatively, a user may indicate a selection of a particular displayed trajectory element through manipulation of one or more other user interface devices 106, 108. For example, a first user interface device may include a keyboard 106, and a user may use arrow keys or other keys to indicate a selection of a particular trajectory element. A second user interface device may include a cursor control device 108 (e.g., a mouse), and a user may position a cursor (e.g., cursor 256, FIG. 2) over a particular trajectory element and depress a select button of the cursor control device to indicate a selection. In addition to facilitating the selection of a trajectory element, the touchscreen, keyboard 106, and/or cursor control device 108 also may be used to add or delete a trajectory element and/or to edit characteristics of a trajectory element, in an embodiment. In an embodiment, characteristics of a trajectory element may automatically be displayed in proximity to the trajectory element when the trajectory element is selected. Characteristics of a trajectory element may include, for example but not by way of limitation, one or more characteristics selected from a group that includes an altitude, a latitude, a longitude, and an airspeed. In an embodiment, for example, after selecting a trajectory element corresponding to a waypoint, a user may edit characteristics defining the waypoint (e.g., an altitude, latitude, and/or longitude) by applying pressure to a portion of a touchscreen other than the current point at which the waypoint is displayed, or by dragging the selected waypoint to a different point on the navigational display device's screen using cursor control device 108, and/or by editing a displayed, textual representation of the waypoint using keyboard 106. Although EFIS 100 is illustrated and described as including a keyboard 106 and a cursor control device 108, it is to be understood that various other types of user interface devices may also or alternatively be used to select, add, and/or delete trajectory elements and/or to edit characteristics of a trajectory element, in other embodiments.

Processing system 110 is adapted to implement a flight plan generation process, a flight path/flight plan display process, and/or a flight plan modification process, according to an embodiment. Each of these processes will be described in greater detail later. Briefly, however, a flight plan generation process may include enabling a user to enter all or a portion of a flight plan by defining characteristics for a plurality of trajectory elements. A flight path/flight plan display process may include causing a display device of the system (e.g., navigational display device 102) to display a depiction of a trajectory. When a flight is in progress, this may include displaying trajectory element indicators corresponding to actual (e.g., previously flown) portions of a flight plan (e.g., the flight path), a portion of the flight plan that is currently being flown, and planned (e.g., upcoming) portions of the flight plan. A flight plan modification process may include enabling a user to select trajectory elements (e.g., graphically depicted as trajectory element indicators), add new trajectory elements, delete existing trajectory elements, and/or modify characteristics (e.g., altitude, latitude, longitude, airspeed, heading, and so on) of existing trajectory elements. In conjunction with the above-described processes, processing system 110 is adapted to cause a three dimensional reference frame (e.g., reference frame 230, FIG. 2) and a three dimensional trajectory depiction (e.g., trajectory depiction 238, FIG. 2) to be rendered on a display device 102-104, wherein the trajectory depiction is rendered in an area defined by the three dimensional reference frame. In an embodiment, some or all of the above-described processes may be implemented using a processing architecture (e.g., processing system 600, FIG. 6) that may be executed on one or more general-purpose or special-purpose processors using associated software and/or firmware defining the processing architecture.

FIG. 2 is an example of a display screen 200 within which a three dimensional trajectory depiction 238 is rendered on a display device (e.g., navigational display device 102, FIG. 1), according to an example embodiment. Display screen 200 includes a trajectory display area 204, which will be described in detail later, and a plurality of selectable icons 210-228. In the illustrated example embodiment, icons 210-228 include a graphical trajectory (GRAPHICAL TRAJ) icon 210, a text trajectory (TEXT TRAJ) icon 211, an airport (AIRPORT) icon 212, a navigational aids (NAVAIDS) icon 213, a runway (RUNWAY) icon 214, a waypoint (WAYPOINT) icon 215, an airways (AIRWAYS) icon 216, a company route (CO ROUTE) icon 217, a reference (REFERENCE) icon 218, a patterns (PATTERNS) icon 219, a scale lateral (SCALE LAT) icon 220, a scale vertical (SCALE VERT) icon 221, a view three dimensional (VIEW 3D) icon 222, a view lateral (VIEW LAT) icon 223, a view vertical (VIEW VERT) icon 224, a smooth trajectory (SMOOTH) icon 225, a display mode icon 226, an editing mode icon 227, and a commit icon 228. Although a set of icons 210-228 corresponding to an example set of functions is illustrated in FIG. 2, it is to be understood that display screen 200 may include more, fewer or different icons, which correspond to more, fewer or different functions. In addition, in various alternate embodiments, the functionality of one or more of icons 210-228 alternatively may be selectable from one or more hidden menus (e.g., drop down menus), from user interface keys, and/or through other hardware and/or software components. In still other embodiments, the layout and arrangement of the icons 210-228 may be different from that illustrated in FIG. 2.

As mentioned previously, the system may operate in a flight path/flight plan display mode and a flight plan editing mode. When the display mode icon 226 is selected, the system may operate in the flight path/flight plan display mode. In this mode, the system may, among other things, display a trajectory depiction in two or three dimensions, where the trajectory depiction corresponds to a flight plan stored in a flight plan data structure (e.g., flight plan data structure 630, FIG. 6) and implemented by the FMS (e.g., FMS 120, FIG. 1, 620, FIG. 6). When the editing mode icon 227 is selected, the system may operate in the flight plan editing mode. While in the flight plan editing mode, an indication that the system is in an editing mode may be displayed (e.g., “EDIT MODE” indication 229), and the functionality provided by a flight plan editor module (e.g., flight plan editor module 604, FIG. 6) may be activated. Accordingly, in the flight plan editing mode, the system may display a depiction of a trajectory in two or three dimensions (e.g., three dimensional trajectory depiction 238), and may further facilitate flight plan generation and/or flight plan modification, according to various embodiments. During the flight plan generation and/or editing process, information defining the new flight plan and/or the edits to a flight plan may temporarily be stored (e.g., in internal data structures, a data storage device 112, FIG. 1, and/or non-persistent trajectory data structure 610, FIG. 6). In an embodiment, a user may indicate a desire to incorporate the changes into a flight plan by selecting the commit icon 228. At that point, a request (e.g., referred to herein as a “flight plan related request”) that includes information defining the new flight plan and/or edits to an existing flight plan may be sent to the FMS (e.g., FMS 120, FIG. 1 or FMS 620, FIG. 6), which may determine whether and how to incorporate the information into a flight plan data structure (e.g., flight plan data structure 630, FIG. 6).

When the text trajectory icon 211 has been selected, a textual representation of a trajectory (not illustrated) may be displayed within trajectory display area 204. A textual representation of a trajectory may include, for example, a sequential list of various trajectory elements, along with their corresponding characteristics. In an embodiment, a user may add, delete, and/or edit the characteristics of the displayed trajectory elements through interaction with one or more user interfaces (e.g., keyboard, cursor control device, and/or touchscreen, for example). Editing of a textual representation of a trajectory is not discussed in detail herein.

When the graphical trajectory icon 210 and the view three dimensional icon 222 have been selected, the system may cause a three dimensional reference frame 230 and a three dimensional trajectory depiction 238 to be displayed within trajectory display area 204. Although only one trajectory depiction 238 is displayed in FIG. 2, multiple different trajectory depictions simultaneously may be displayed within trajectory display area 204, in an embodiment. For example, multiple different trajectories may be displayed simultaneously for comparison purposes, and/or a trajectory and an edited version of the same trajectory may be displayed simultaneously.

Three dimensional reference frame 230 includes a cubic reference frame, in an embodiment, which is configured to create a sense of depth in the display. In an embodiment, reference frame 230 includes a bottom plane 232, a first side plane 234 (e.g., a back, right side plane), a second side plane 236 (e.g., a back, left side plane), and a bearing circle 233. In an embodiment, each of the bottom plane 232 and the first and second side planes 234, 236 are visibly rendered. In alternate embodiments, one or more of the bottom plane 232 and/or the first and second side planes 234, 236 may not be visibly rendered. Bottom plane 232 includes a planar representation of the ground between at least a departure airport (e.g., as represented by trajectory element 240) and an arrival airport (e.g., as represented by trajectory element 247). Bottom plane 232 may be represented as a planar grid having latitude reference lines and longitude reference lines, as shown, which are adapted to provide latitude and longitude references, respectively. In an alternate embodiment, bottom plane 232 may indicate topographical elements, and thus may be contoured. Bearing circle 233 may circumscribe bottom plane 232, as illustrated, and may include bearing values (not illustrated) plotted around its circumference. A compass indicator, such as a true or magnetic north arrow 239 may be displayed within trajectory display area 204 in relation to the bearing circle 233. First and second side planes 234, 236 may include substantially horizontal altitude reference lines, as shown, which are adapted to provide altitude references. First and second side planes 234, 236 may intersect bottom plane 232, as illustrated, in an embodiment. In another embodiment, first and second side planes 234, 236 may be detached or elevated from bottom plane 232.

In other embodiments, the reference frame may include one, two or three additional planes in order to provide a four-sided, five-sided, or six-sided cubic reference frame, respectively. For example, a top plane (not illustrated) may intersect the top edges of the first and second side planes 234, 236, a third side plane (not illustrated) may intersect the right side edges of the first side plane 234 and the bottom plane 232, and/or a fourth side plane (not illustrated) may intersect the left side edge of the second side plane 236 and the front edge of the bottom plane 232. In such other embodiments, one or more of the additional planes may appear transparent (e.g., as with a screen) to enable viewing of portions of a trajectory depiction that may be rendered behind the additional planes. In an embodiment, the system may be adapted to enable a user to configure the way that reference frame 230 is displayed by providing prompts to enable the user to select various display options for the reference frame 230 (e.g., such as the display options discussed above).

In an embodiment, the system is adapted to render three dimensional trajectory depiction 238 in an area defined by three dimensional reference frame 230. Three dimensional trajectory depiction 238 includes at least one trajectory element indicator (e.g., one or more of trajectory element indicators 240-254) that corresponds to at least one trajectory element. In the illustrated example, three dimensional trajectory depiction 238 may include a plurality of trajectory element indicators 240, 241, 242, 243, 244, 245, 246, 247, 248, 249, 250, 251, 252, 253, 254 that correspond to a plurality of trajectory elements. The illustrated trajectory element indicators 240-254 indicate an example trajectory, and it is to be understood that other trajectories may be represented by more, fewer or different trajectory element indicators. Trajectory element indicators 240 and 247 may indicate a departure point (e.g., a departure airport) and an arrival point (e.g., a destination airport), respectively. It is to be understood that, in an embodiment, trajectory element indicators corresponding to a departure point and/or an arrival point may be positioned anywhere within a reference frame, and not necessarily in a corner and/or at the level of the bottom plane 232.

Trajectory element indicators 248-254 may indicate trajectory segments (e.g., indicators of a flight path between two waypoints), and may be referred to herein as “flight leg indicators.” In contrast, trajectory element indicators 241-246 may indicate waypoints (e.g., points in space along a flight path) between the departure point and the arrival point. Along with the departure point and arrival point indicators (e.g., trajectory element indicators 240 and 247), trajectory element indicators 241-246 may be referred to herein as “waypoint indicators.” In some cases, waypoint indicators 241-246 may represent maneuver points along the flight path. For example, waypoint indicator 243 may represent a top of climb (TOC) point and waypoint indicator 244 may represent a top of descent (TOD) point. Other waypoint indicators may indicate the location of a navigation aid (e.g., a VOR beacon, an NDB, or another navigation aid) or other navigational point at which the aircraft may execute a turn and/or an altitude change. Each type of trajectory element indicator 241-254 may have a same format when displayed (e.g., same size, color, thickness, and/or other characteristics), in an embodiment. In alternate embodiments, the sizes, colors, thicknesses or other characteristics of trajectory element indicators 241-254 of a certain type may be different, where the differences may assist in the creation of a sense of depth. For example, a waypoint indicator (e.g., waypoint indicator 240) positioned toward the front of the bottom plane 232 (e.g., closer to the user) may be displayed larger and/or darker than a waypoint indicator (e.g., waypoint indicator 246) positioned toward the back of the bottom plane 232 (e.g., farther from the user). Other characteristics of trajectory element indicators 241-254 may be varied to indicate relative distances of the trajectory element indicators 241-254 from the perspective of the user.

In an embodiment, three dimensional trajectory depiction 238 also may include one or more vertical, altitude indicator lines 270 extending between waypoint indicators 241-246 and corresponding ground plane indicators 272 on bottom plane 232. Accordingly, altitude indicator lines 270 may represent relative altitudes along a flight path.

Three dimensional trajectory depiction 238 may represent past, current, and planned portions of a flight path. In an embodiment, during a flight, bypassed waypoints and completed flight legs (e.g., trajectory element indicators 240-245 and 248-252) may be indicated in one manner (e.g., with solid circles and solid lines, as illustrated), and future, planned waypoints and flight legs (e.g., trajectory element indicators 246, 247, and 254) may be indicated in another manner (e.g., with hollow circles and dashed lines, as illustrated). The current location of the aircraft may be indicated by a current location indicator (e.g., aircraft indicator 280), which may track along the trajectory as the flight progresses.

In an embodiment, the display screen upon which icons 210-228, reference frame 230, and trajectory depiction 238 are displayed may include a touchscreen, as previously discussed. In such an embodiment, a user may select a desired icon 210-228 and/or a trajectory element indicator 240-254 by applying pressure (e.g., using the user's finger or a stylus, for example) to a portion of the surface of the display screen at which the desired icon 210-228 or trajectory element indicator 240-254 is displayed.

In another embodiment, a user may select a desired icon 210-228 and/or a trajectory element indicator 240-254 using a cursor control device (e.g., cursor control device 108, FIG. 1) and/or using keys on a keyboard (e.g., keyboard 106, FIG. 1). In an embodiment, when a cursor control device (e.g., cursor control device 108, FIG. 1) is used to move a displayed cursor 256 through the reference frame 230, a trajectory element indicator 240-254 over which the cursor 256 is moved may be displayed in highlighted difference (e.g., brighter, in contrasting color, flashing, and/or other perceptible difference) from the other trajectory element indicators 240-254 to indicate the trajectory element indicator 240-254 that is the current focus of the cursor 256. In addition, in an embodiment, one or more characteristics (e.g., airspeed, heading, altitude, latitude, and/or longitude) of the trajectory element indicator 250-254 that is the current focus of the cursor 256 may be displayed. In an embodiment, regardless of how a trajectory element indicator 240-254 has been selected, a selection indicator (e.g., dashed circle surrounding trajectory element indicator 245) may be displayed, and/or one or more characteristics 260 (e.g., airspeed, heading, altitude, latitude, and/or longitude) of the selected trajectory element indicator also may be displayed. In an embodiment, the system is adapted to enable a user to edit or define characteristics of a trajectory element directly, such as by selecting a box within which a trajectory element indicator's characteristics are displayed (e.g., characteristics 260), and editing one or more of the characteristics using a keyboard (e.g., keyboard 106, FIG. 1) or other user interface device. The system may provide other methods for directly editing or defining characteristics of a trajectory element, in other embodiments.

In an embodiment, the system (e.g., processing system 110, FIG. 1) is adapted to receive, from a user interface device (e.g., a touchscreen, keyboard 106, and/or cursor control device 108, FIG. 1), one or more user interface inputs that indicate user selection of a selected trajectory element indicator 240-254. Upon selecting a particular trajectory element indicator 240-254, a user may modify one or more characteristics of the trajectory element corresponding to the selected trajectory element indicator 240-254, in an embodiment, through direct interaction with the selected trajectory element indicator 240-254 via one or more of the user interface devices (e.g., a touchscreen, cursor control device 108, FIG. 1, and/or keyboard 106, FIG. 1). In an embodiment, processing system 110 is further adapted to receive, from a user interface device, one or more user interface inputs that indicate user-initiated movement of a selected trajectory element indicator 240-254 from a first display position to a second display position within the three dimensional reference frame 230. Processing system 110 may modify one or more characteristics of a trajectory element corresponding to the selected trajectory element indicator 240-254, and to cause a modified trajectory depiction to be rendered with the selected trajectory element indicator 240-254 located in the second display position. In an embodiment, as a selected trajectory element indicator 240-254 is being moved (e.g., dragged) from the first display position to the second display position, processing system 110 is further adapted continuously to update the rendered trajectory depiction 238 to maintain continuity of the trajectory.

For example, in an embodiment, one or more user interface inputs that indicate selection by a user of a selected trajectory element indicator (e.g., waypoint indicator 245) and user-initiated movement of the selected trajectory element indicator may be received from a touchscreen. In such an embodiment, the user may select waypoint indicator 245 and drag the selected waypoint indicator 245 from the first display position to the second display position by applying pressure to a display surface of the touchscreen. More particularly, a user interface input that indicates user selection of waypoint 245 may be generated in response to the user applying pressure to a portion of the display surface of the touchscreen at which the selected trajectory element indicator is displayed. A user interface input that indicates user-initiated movement of the selected trajectory element indicator may be generated in response to the user continuously applying the pressure to the display surface between the first display position and the second display position, and removing the pressure at the second display position.

In another embodiment, one or more user interface inputs that indicate selection by a user of a selected trajectory element indicator (e.g., waypoint indicator 245) and user-initiated movement of the selected trajectory element indicator may be received from a cursor control device (e.g., cursor control device 108, FIG. 1). In such an embodiment, the user may select waypoint indicator 245 and drag the selected waypoint indicator 245 from the first display position to the second display position by manipulating the cursor control device. More particularly, a user interface input that indicates user selection of the waypoint indicator 245 may be generated by the cursor control device in response to the user manipulating the cursor control device to cause cursor 256 to be positioned over waypoint indicator 245, and the user depressing (e.g., “clicking”) a select button of the cursor control device while the cursor is positioned over waypoint indicator 245. A user interface input that indicates user-initiated movement of the selected trajectory element may be generated by the cursor control device in response to the user manipulating the cursor control device to drag the waypoint indicator 245 from the first display position to the second display position while the select button is depressed, and to drop the selected trajectory element at the second display position by releasing the select button.

Regardless of the user interface device used to modify the characteristics of waypoint indicator 245, the system will cause a modified trajectory depiction to be rendered, which includes waypoint indicator 245 located at the second display position. In an embodiment, the system may provide the user with options to undo and/or redo one or more (e.g., a sequence) of modifications to a trajectory. In an embodiment, as waypoint indicator 245 is dragged from the first display position to the second display position, the system may cause flight leg indicators 252 and 253 connected to waypoint indicator 245 to be displayed in a manner that the flight leg indicators 252, 253 appear to stretch or compress in order to maintain connectivity between waypoint indicator 245 and adjacent waypoint indicators 244 and 246.

The perspective (e.g., direction and/or elevation angle) from which the three dimensional trajectory depiction 238 is displayed may be changed, as will be described below, to facilitate the user's ability accurately to move the waypoint indicator 245 to a desired second display position. In an embodiment, each waypoint indicator 245 that is positioned above the ground plane 232 may have an associated ground plane indicator 272 at the bottom of its associated altitude indicator line 270, and the ground plane indicator 272 may be dragged across the ground plane 232 to implement horizontal changes (e.g., changes in latitude and/or longitude) to the selected waypoint indicator 245. In such an embodiment, the selected waypoint indicator 245 itself may be dragged only in a vertical direction to implement vertical changes (e.g., changes in altitude) to the selected waypoint indicator 245.

As the user is dragging a selected waypoint indicator 245 from the first display position toward the second display position, the displayed characteristics 260 may be continuously updated to assist the user in dropping the selected waypoint indicator 245 at the second display position, in an embodiment. In another embodiment, the displayed characteristics 260 may be updated only when the user has paused while dragging a selected trajectory element indicator 240-254 and/or when the user has dropped the selected trajectory element indicator 240-254. In yet another embodiment, the user may cause a selected trajectory element indicator 240-254 to be re-positioned within the reference frame 230 by editing the displayed characteristics 260 using keys on a keyboard (e.g., keyboard 106, FIG. 1). For example, when a user enters a new altitude, latitude, and/or longitude, the selected trajectory element indicator 240-254 may appear to snap from a first display position indicated by the previous characteristics to a second display position indicated by the edited characteristics.

Permissible edits to trajectory element indicators 240-254 may be limited and/or configurable, in various embodiments. For example, a system may be configured to allow a waypoint indicator that is positioned on bottom plane 232 (e.g., waypoint indicators 240 and 247) to be dragged only in a vertical direction, in an embodiment. In addition or alternatively, a system may be configured to allow a waypoint indicator to be moved vertically up to a threshold altitude. In other embodiments, a system may be configured to include additional or different permissible trajectory element indicator edits.

Functionality of the other icons 212-223 that have not yet been discussed in detail now will be described briefly. When the airport icon 212 is selected, the system may display the locations of one or more airports within a selected region and/or a region corresponding to the reference frame 230, in an embodiment. When the navigational aids icon 213 is selected, the system may display the locations of one or more navigation aid (e.g., VOR beacons, NDBs, or other navigation aids) within a selected region and/or a region corresponding to the reference frame 230, in an embodiment. When the runway icon 214 is selected, the system may display the locations of one or more airport runways, in an embodiment. In addition, the system may display the orientations of the displayed runways.

When the waypoint icon 215 is selected, the system may display the locations of one or more waypoints within a selected region and/or a region corresponding to the reference frame 230, in an embodiment. When a particular one of waypoint indicators 241-246 is selected (e.g., by the user moving cursor 256 over or in proximity to a waypoint indicator and depressing a mouse button), the system may provide displayed prompts which may enable the user to access or perform various processes relating to the selected waypoint indicator 241-246, in an embodiment. For example, the system may provide a number of waypoint-related options, such as a “center map” option, a “go direct to waypoint” option, a “delete waypoint” option, a “show information” option, and a “hold” option, to name a few examples. A user may indicate selection of an option, for example, by scrolling through the options (e.g., using arrow keys on keyboard 106, FIG. 1), by selecting an option using a cursor control device (e.g., cursor control device 108, FIG. 1) or, when the display device includes a touchscreen, by applying pressure (e.g., using the pilot's finger or a stylus) to the portion of the touchscreen where a desired option is displayed.

For example, selection of a “center map” option may cause the system to center the displayed three dimensional trajectory depiction 238 on a selected waypoint indicator 241-246. Selection of a “go direct to waypoint” option may cause the system to edit the flight plan to include a flight leg that extends directly from a current position to a selected waypoint indicator 241-246, or to include a flight leg that extends directly between two selected waypoint indicators 241-246. Selection of a “delete waypoint” option may cause the system to edit the flight plan to exclude a selected waypoint indicator 241-246 and any flight leg indicators 248-254 that connect to the selected waypoint indicator 241-246, and to include a new flight leg indicator (not illustrated) that extends directly from the two waypoint indicators 241-246 that immediately preceded and followed the selected waypoint indicator 241-246. Selection of a “show information” option may cause the system to display characteristics (e.g., sequence information, altitude, latitude, longitude, airspeed, heading, and so on) of a selected waypoint indicator 241-246. Finally, selection of a “hold” option may cause the system to edit the flight plan to define a selected waypoint indicator 241-246 as a holding fix point of a holding pattern. More, fewer or different waypoint-related options than those discussed above may be provided by a system, in other embodiments.

When the airways icon 216 is selected, the system may display airways (e.g., designated routes in the air) surrounding and/or in proximity to a selected waypoint indicator and/or a selected area within the reference frame 230, in an embodiment.

When the company route icon 217 is selected, the system may display one or more company route trajectories within a selected region and/or a region corresponding to the reference frame 230, in an embodiment.

When the reference icon 218 is selected, the system may provide displayed prompts which the user may change the reference point in space from which the trajectory is viewed, in an embodiment. For example, three dimensional trajectory depiction 238 is rendered from a reference point in space that is above bottom plane 232, and to the northeast of the trajectory depicted by three dimensional trajectory depiction 238. In an embodiment, upon selecting reference icon 218, the system may provide the user with the ability to indicate a new vertical viewing angle and/or a new height above bottom plane 232. Regardless of the viewing angle and/or reference point, the system is adapted to cause displayed text (e.g., characteristics 260, among other things) to be in an orientation in which it is readable, in an embodiment.

In an embodiment, when the reference icon 218 is selected, the system also or alternatively may provide prompts which enable the user to indicate a reference “fix point.” For example, a reference fix point may be a trajectory element indicator (e.g., trajectory element indicator 240) or a reference fix point may be a point that is fixed with respect to the reference frame 230 (e.g., a waypoint indicator 241-246). In an embodiment, when the user indicates a trajectory element indicator as the reference fix point, then during a flight, the reference frame 230 may appear to remain stationary and a current location indicator (e.g., aircraft indicator 280) may appear to move along the three dimensional trajectory depiction 238 as the flight progresses. Alternatively, when the user indicates a fixed point with respect to the reference frame 230 as the reference fix point, then during a flight, the current location indicator (e.g., aircraft indicator 280) may appear to remain stationary and the reference frame 230 and three dimensional trajectory depiction 238 may appear to move with respect to the current location indicator as the flight progresses.

When the patterns icon 219 is selected, the system may provide the user with an ability to select a trajectory pattern from a group of trajectory patterns that is accessible to the system, and to incorporate the selected trajectory pattern into the flight plan. For example, the group of trajectory patterns may include a straight line pattern, a curved line pattern (e.g., of various radian angles), a holding pattern, an orbit pattern, a procedure turn pattern, a spiral pattern with varying altitude and/or radius, a convolute pattern, and so on. Each trajectory pattern may include a plurality of trajectory element indicators (e.g., departure point, one or more waypoint indicators, one or more flight leg indicators, and an arrival point) having a unique relationship to each other, when compared with other trajectory patterns. In an embodiment, the system also may provide the user with the ability to add the selected pattern to the reference frame (e.g., reference frame 230), and to fix one or more of the pattern's trajectory element indicators to points within the reference frame. A pattern may be used as a starting point to define an entire trajectory, or a pattern may be incorporated as a portion of a trajectory. For example, the user may select a trajectory element indicator corresponding to a departure airport to be fixed to a lower, left corner of the bottom plane (e.g., bottom plane 232) of the reference frame, and may cause a trajectory element indicator corresponding to an arrival airport to be fixed to an upper, right corner of the bottom plane. The user may then add, delete, and/or modify waypoints between the departure airport and the arrival airport and apply any previously mentioned trajectory pattern on any waypoint indicator 241-246. As another example, the user may select a trajectory pattern for a holding pattern, and may cause trajectory element indicators corresponding to entry and exit points of the holding pattern to be positioned at intermediate points in a trajectory. When the system receives one or more user interface commands indicating a user selection of a pattern to be incorporated into the flight plan, the system may add a plurality of new trajectory elements to the flight plan, which correspond to the pattern.

In an embodiment, each of the planes 232, 234, 236 of the reference frame 230 may include numeric markings (not illustrated, e.g., altitudes, distances, latitudes or longitudes) that may indicate the scale of the various planes 232, 234, 236. As a default, for example, the system may set a display scale as 10:1, 20:1, 40:1 or another pre-programmed default setting for the three orthogonal axes represented by the intersections of the bottom plane 232 and the first and second side planes 234, 236. Scale indicators (not illustrated) may be displayed to inform the user of the display scale for each of the axes. When the scale lateral icon 220 is selected, the system may provide displayed prompts which the user may manipulate to increase or decrease the lateral scale of the reference frame (e.g., reference frame 230) with respect to the vertical scale of the reference frame, in an embodiment. Similarly, when the scale vertical icon 221 is selected, the system may provide displayed prompts which the user may manipulate to increase or decrease the vertical scale of the reference frame (e.g., reference frame 230) with respect to the lateral scale of the reference frame, in an embodiment. By manipulating the scale settings and setting a reference point (described above in conjunction with the description of the reference icon 218), a user may cause the display to “zoom in to” or “zoom out from” portions of the displayed trajectory. In addition, in an embodiment, the system is adapted to enable the user to specify a starting vertical point (e.g., an altitude for the lowest trajectory element indicator and/or the bottom plane 232).

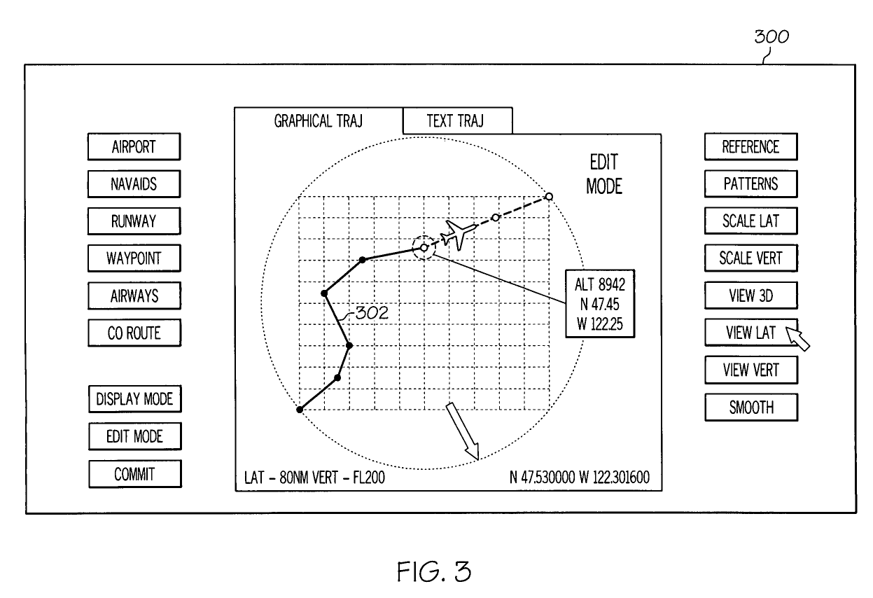

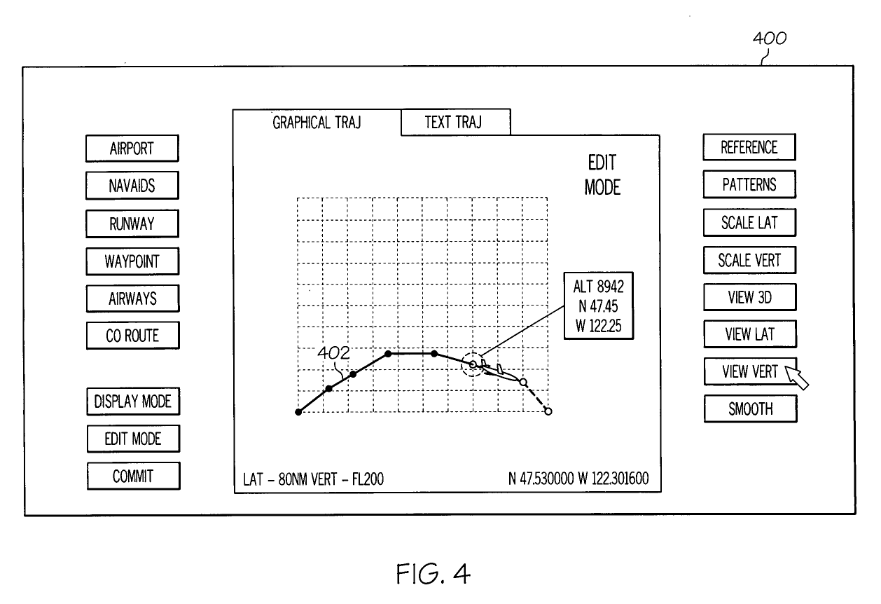

When the view lateral icon 223 is selected, the system may cause a lateral representation of the trajectory to be displayed, in an embodiment, rather than a three dimensional representation of the trajectory (e.g., three dimensional trajectory depiction 238). For example, FIG. 3 is an example of a display screen 300 within which a lateral trajectory depiction 302 is rendered on a display device, according to an example embodiment. The lateral trajectory depiction 302 corresponds to a view of the trajectory from the top, or the ground path that the trajectory would follow. Accordingly, the lateral trajectory depiction 302 corresponds to the trajectory translated onto a bottom plane (e.g., bottom plane 232, FIG. 2). Similarly, when the view vertical icon 224 is selected, the system may cause a vertical representation of the trajectory to be displayed, in an embodiment. For example, FIG. 4 is an example of a display screen 400 within which a vertical trajectory depiction 402 is rendered on a display device, according to an example embodiment. The vertical trajectory depiction 402 corresponds to a view of the trajectory from the side, which may indicate the sequence of altitudes that the trajectory would follow. Accordingly, the vertical trajectory depiction 402 corresponds to the trajectory translated onto a side plane. Accordingly, by selecting the view 3D icon 222, view lateral icon 223, or the view vertical icon 224 a user may cause the system to toggle between displaying a three dimensional representation of a trajectory, a two dimensional lateral representation of the trajectory, and a two dimensional vertical representation of the trajectory. Referring back to FIG. 2, although trajectory display area 204 is shown to render only one type of trajectory view (e.g., three dimensional trajectory depiction 238), trajectory display area 204 may be configurable simultaneously to render multiple trajectory views.

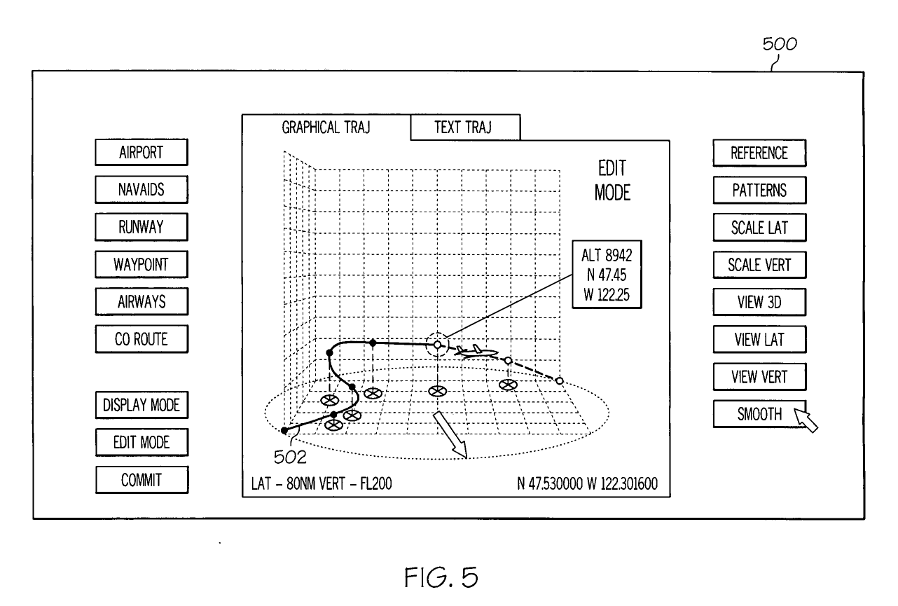

The trajectory depictions of FIGS. 2-4 include linear flight leg indicators (e.g., flight leg indicators 248-254, FIG. 2) interconnecting waypoint indicators (e.g., waypoint indicators 241-246, FIG. 2). Due to maneuverability constraints, an aircraft will actually follow a curved trajectory during flight, rather than following a trajectory having abrupt corners, as is depicted in FIGS. 2-4. In an embodiment, the system is further adapted to calculate a smoothed trajectory based on maneuverability constraints of the aircraft, where the smoothed trajectory includes one or more curved flight leg indicators between one or more waypoint indicators. The system is also adapted to cause the smoothed trajectory to be displayed automatically or in response to a user input. In a particular embodiment, when the smooth trajectory icon 225 is selected, the system may calculate and cause a smoothed representation of the trajectory to be displayed. The smoothed representation of a trajectory may be calculated and displayed for a three dimensional trajectory depiction or a two dimensional trajectory depiction (e.g., a lateral or vertical trajectory depiction). As an example, FIG. 5 is an example of a display screen 500 within which a smoothed, three dimensional trajectory depiction 502 is rendered on a display device, according to an example embodiment. As three dimensional trajectory depiction 502 illustrates, a smoothed, three dimensional trajectory depiction may include curved and/or linear flight leg indicators between waypoint indicators.

FIG. 2, described above, illustrates a three dimensional trajectory depiction 238 for a defined flight plan. In an embodiment, a user may define a new three dimensional trajectory depiction by initiating an instance of a flight plan editing module (e.g., flight plan editor module 604, FIG. 6), which may cause a display screen with an empty reference frame (e.g., reference frame 230) to be displayed. The user may add one or more waypoints (e.g., represented by waypoint indicators 241-246) to define the trajectory. In addition, in an embodiment, the user may select one or more patterns, as described above, and apply the patterns on a particular waypoint indicator. In another embodiment, a user may define a new three dimensional trajectory depiction by sequentially selecting (e.g., using cursor control device 108, FIG. 1) points within a displayed reference frame (e.g., reference frame 230), where each point may correspond to a waypoint (e.g., a departure point, waypoint, and arrival point). In some cases, when a waypoint is being defined based on a navigational aid and/or other geographically-fixed objects, information characterizing the waypoint may be stored in and accessed from a navigational database (e.g., navigational database 622, FIG. 6). The system automatically may add trajectory element indicators (e.g., trajectory element indicators 240-247) and connectors between adjacent trajectory element indicators (e.g., flight leg indicators 248-254) as the waypoints are added to the three dimensional trajectory depiction. In an embodiment, each waypoint indicator that will be positioned above the ground plane (e.g., ground plane 232) may be added by selecting a point on the ground plane to define the waypoint's latitude and longitude (e.g., by positioning a cursor over the point and depressing a select button of a cursor control device or by touching the point on a touchscreen surface). The system may be configured thereafter to allow the newly added waypoint indicator to be dragged only in the vertical direction to define the waypoint indicator's altitude. As described earlier, the waypoint indicator (e.g., waypoint indicator 245 may have associated therewith an altitude indicator line (e.g., altitude indicator line 270) to indicate its altitude, and a ground plane indicator (e.g., ground plane indicator 262) to indicate its latitude and longitude. Once a trajectory that includes at least one trajectory element indicator has been created and displayed, the system may enable the user to edit characteristics of one or more of the trajectory element indicator, as described previously.

As also described previously, an electronic flight instrument system (e.g., EFIS. 100, FIG. 1) may function as a front-end user interface for flight plan generation and/or modification processes, whereas a flight management system (e.g., FMS 120, FIG. 1) may function as a back-end controller for storing, editing, and implementing flight plans within a flight plan data structure. As a flight plan initially is being created within the context of the EFIS, information defining the trajectory (e.g., characteristics defining trajectory element indicators, among other things) may temporarily be stored (e.g., in internal data structures, a data storage device 112, FIG. 1, and/or non-persistent trajectory data structure 610, FIG. 6). In an embodiment, the system may provide the user with an option to identify (e.g., specify a filename) and save information defining the trajectory in a partially-completed or completed form. A user may indicate his or her desire for a newly created flight plan and/or modifications to an existing flight plan to be incorporated into an actual flight plan that is implemented by the FMS (e.g., FMS 120, FIG. 1 or FMS 620, FIG. 6) and stored in a flight plan data structure (e.g., flight plan data structure 630, FIG. 6) that is accessible to the FMS, as described previously. Alternatively, when the system is implemented in an environment other than an aircraft (e.g., a ground control station), a user may indicate his or her desire for a newly created flight plan and/or modifications to an existing flight plan to be stored in permanent memory (e.g., as a file). For example, the user may select the commit icon 228 (FIG. 2) to indicate such a desire. The EFIS may be adapted to send flight plan related requests to the FMS, which may convey information relating to newly-generated flight plans and/or modifications to flight plans. The FMS may evaluate the requests and determine whether or not to incorporate information included in the requests into a flight plan stored in the flight plan data structure.

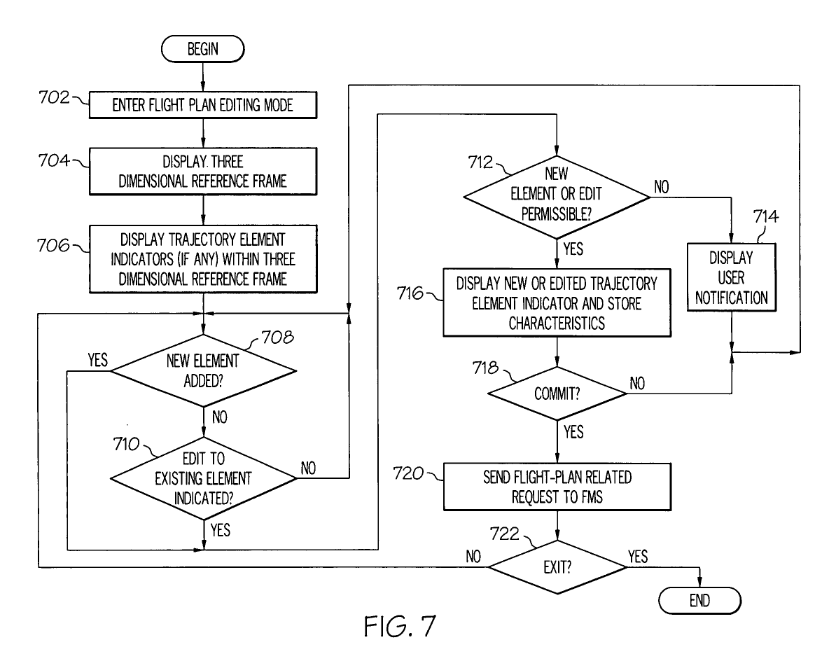

Up to this point, electronic flight instrument systems (e.g., system 100, FIG. 1) and display screens (e.g., display screens 200, 300, 400, 500, FIGS. 2-5) that may be displayed on display devices of such systems have been described, according to various example embodiments. Embodiments of processing architectures and methods for generating a flight plan, displaying flight paths and flight plans, and modifying flight plans will now be described in conjunction with FIGS. 6 and 7.

More specifically, FIG. 6 is a simplified, functional block diagram of a flight plan processing system 600, which is adapted to interface with an FMS 620 (e.g., FMS 120, FIG. 1), a navigational database 622, one or more display devices 624 (e.g., display devices 102-104, FIG. 1), and one or more user interface devices 626 (e.g., keyboard 106, cursor control device 108, and/or a touchscreen associated with one or more of display devices 624). System 600 may be implemented by portions of an electronic flight instrument system, such as an embodiment of the processing system 110 of EFIS 100 (FIG. 1).

In an embodiment, system 600 is adapted to perform a flight path/flight plan display process, a flight plan generation process, and/or a flight plan modification process, according to various embodiments. In an embodiment, when the system is configured in a flight path/flight plan display mode, the system may perform the flight path/flight plan display process. Alternatively, when the system is configured in a flight plan editing mode, the system may perform the flight path/flight plan display process, along with the flight plan generation process, and/or the flight plan modification process, according to various embodiments. As mentioned previously, the flight path/flight plan display process may include causing a display device 624 (e.g., navigational display device 102, FIG. 1) to display a depiction of a trajectory defined by a flight plan and portions of a flight plan that may have been completed (e.g., a flight path). The flight plan generation process may include enabling a user to enter all or a portion of a flight plan by manipulating one or more user interface devices 626 in a manner that causes the system to define characteristics for a plurality of trajectory elements (e.g., by creating trajectory element indicators 240-254, FIG. 2). Finally, the flight plan modification process may include enabling a user to modify a flight plan, such as by selecting displayed trajectory element indicators, adding new trajectory elements, deleting existing trajectory elements, and/or modifying characteristics (e.g., altitude, latitude, longitude, airspeed, heading, and so on) of existing trajectory elements by manipulating one or more user interface devices 626.

In an embodiment, system 600 may include a display module 602, a flight plan editor module 604, and one or more external entity interfaces 606. External entity interfaces 606 are adapted to enable system 600 to exchange information with FMS 620 (e.g., FMS 120, FIG. 1), a navigational database 622, and/or another external entity. In an embodiment, external entity interfaces 602 include standard and/or predefined software interfaces through which system 600 receives flight plan and/or flight path data as input and sends modified flight plan data as output (e.g., in the form of flight plan modification requests), among other things.

FMS 620 is adapted to perform lateral, vertical (e.g., altitude), and/or predicted flight path computations based on the aircraft's current lateral position (e.g., latitude and longitude), current altitude, current operational state, and a computer-readable version of a pre-defined flight plan that is accessible to FMS 620. The pre-defined flight plan may be stored, for example, in flight plan data structure 630. In addition, FMS 620 is adapted to exchange information (e.g., flight plan data, flight path information, flight plan modification requests, commands, and/or navigational information) with system 600, in order to enable system 600 to cause a representation of a flight plan and/or a flight path to be displayed by a display device 624. For example, FMS 620 is adapted to send trajectory related information to system 600, and system 600 is adapted to render a trajectory depiction (e.g., trajectory depictions 238, 302, 402, 502, FIGS. 2-5) based on the trajectory related information. The trajectory related information may include information relating to a flight plan and/or information relating to a flight path. In addition, information exchanged between system 600 and FMS 620 may enable FMS 620 to evaluate requests for modifications to flight plans (e.g., modified flight plan data), and when FMS 620 determines to grant the requests, to commit the requested modifications to a flight plan by storing information reflecting the modifications in flight plan data structure 630.

Navigational database 622 may include navigational information relating to fixed-position navigational aids (e.g., VOR beacons, NDBs, and other navigational aids), airport locations, runway information, and airway definitions, among other things. The navigational information may be accessed by system 600 via an external entity interface 606 when, for example, a user has indicated that he or she would like representations of navigational information to be displayed, and/or when the system 600 determines that the navigational information may be needed during the flight plan generation process and/or the flight plan modification process. Navigational information may be stored, for example but not by way of limitation, in the form of binary files, text files, and/or other types of file formats.

The navigational information that is retrieved and rendered may be affected by a user's selection of various navigation related display options. For example, referring also to FIG. 2, user selection of navigation related display options may be prompted, in an embodiment, by providing display options such as airport icon 212, navaids icon 213, runway icon 214, and/or airways icon 216, where the functionality of each of these icons was described above. In response to a user selection of one of the aforementioned icons, system 600 may retrieve navigational information from navigational database 622 relating to airports, navigational aids, runways, and/or airways, respectively. System 600 may thereafter evaluate the navigational information and may generate corresponding display commands. Other methods for prompting user selection of navigation related display options alternatively may be implemented, in other embodiments. In an embodiment, a database manager application (not illustrated) may receive requests for navigational information from system 600, and may access and decode the requested data from the navigational database 622, and provide the decoded data to system 600 via an external entity interface 606. In other embodiments, system 600 may interface with database manager applications for various databases other than navigational database 622.

Referring again to system 600, display module 602 is adapted to perform computational and control portions of the flight path/flight plan display process when system 600 is in the flight path/flight plan display mode. More particularly, display module 602 is adapted to receive information that describes a flight plan (e.g., from FMS 620), a previously flown flight path (e.g., from FMS 620), and/or modifications to a flight plan (e.g., from flight plan editor module 604), and to generate display commands that cause a display device 624 to display one or more depictions of a flight path and/or flight plan in two or three dimensions. Accordingly, for example, FMS 620 may retrieve flight plan data from flight plan data structure 630, and may provide the flight plan data to display module 602 via an external entity interface 606. In addition, FMS 620 may provide flight path data to display module 602 via an external entity interface 606, where the flight path data indicates an actual flight path followed by an aircraft during a flight. Flight plan data structure 630 may include flight plan data for a plurality of trajectories (e.g., multiple trajectories of one aircraft or trajectories of multiple aircraft). Accordingly, for example, in an environment (e.g., a ground control station) in which a plurality of instances of system 600 simultaneously may be instantiated on network-connected computers, a user of one of the multiple computers may cause system 600 simultaneously to display a trajectory that the user is modifying for a first aircraft along with trajectories for one or more other aircraft that other users may be modifying. In other words, system 600 is adapted to enable multiple users collaboratively to plan trajectories of multiple aircraft when multiple instances of system 600 are instantiated on multiple network-connected computers.

Display module 602 may evaluate the flight plan data and/or flight path data, and based on the evaluation, may send display commands to a display device 624 that cause a display device 624 to display one or more two dimensional or three dimensional depictions of trajectories according to the flight plan data and/or the flight path data (e.g., trajectory depictions 238, 302, 402, 502, FIGS. 2-5). For example, display module 602 may receive flight plan data relating to defined characteristics of various trajectory elements, and may cause trajectory element indicators (e.g., trajectory element indicators 240-254, FIG. 2) to be displayed in a trajectory display area (e.g., trajectory display area 204, FIG. 2).

Flight plan editor module 604 is adapted to perform computational and control portions of the flight plan generation process and/or the flight plan modification process when system 600 is in the flight plan editing mode. In an embodiment, flight plan editor module 604 includes a concurrency update module 620, a permissions module 622, and a customization module 624.

Concurrency update module 620 is a software module adapted to receive user input commands relating to potential modifications or edits to a flight plan from one or more sources. For example, concurrency update module 620 may receive user input commands from one or more user interface devices 626, which indicate that: 1) a user would like a new trajectory element to be defined; 2) the user has selected a trajectory element indicator corresponding to a particular trajectory element; 3) the user would like a trajectory element corresponding to a selected trajectory element indicator to be deleted; 4) and/or the user would like the characteristics of a trajectory element corresponding to a selected trajectory element indicator to be modified.

In an embodiment, concurrency update module 620 is further adapted to prioritize multiple inputs and to determine which input to apply when flight plan editor module 604 receives multiple user input commands relating to potential flight plan modifications that may be in conflict with each other. For example a first user (e.g., a captain) may provide a first user input that corresponds to a potential modification to a flight plan that is being depicted on a display device 624, and a second user (e.g., a co-pilot) nearly simultaneously may provide a second user input that corresponds to another potential modification to the flight plan. Concurrency update module 620 may determine which potential modification to apply based on a pre-defined prioritization scheme. In addition, concurrency update module 620 may cause display module 602 to display one or more indications to the first user and/or the second user to indicate the conflicting potential modifications.

In an embodiment, during a flight, concurrency update module 620 is also adapted to receive information from FMS 620 via an external entity interface 606 relating to a flight path that is being flown. Based on that information, concurrency update module 620 may provide signals, information and/or data (referred to herein as “flight path/plan display commands”) to display module 602, which enable display module 602 to cause a display device 624 to display an updated version of the portion of a flight plan that has been flown (e.g., the flight path) and the portion of the flight plan that has not yet been flown. In an embodiment, this is achieved by updating the position of a displayed object (e.g., aircraft indicator 280, FIG. 2) along a displayed trajectory (e.g., trajectory 238, FIG. 2) in real time. In this manner, concurrency update module 620 may maintain a flow of information to the display module 602 relating to flight path and flight plan updates.

In an embodiment, permissions module 622 is adapted to determine whether requested edits to a flight plan are permissible. For example, permissions module 622 may evaluate information for a requested new trajectory element or an edit to an existing trajectory element, and may determine whether one or more characteristics of the new trajectory element or the edited trajectory element fall outside of acceptable ranges or exceed thresholds (e.g., the trajectory element is outside of an airway, at an unacceptable altitude, at a position to which the aircraft is incapable of maneuvering, and so on). When a potential edit is permissible, flight plan editor module 604 may provide signals, information and/or data reflecting the potential edit (referred to herein as “flight plan edit commands”) to display module 602. Display module 602, in turn, may generate display commands that cause a display device 624 to display a version of a flight plan that includes or indicates the potential edit. When a potential edit is not permissible, permissions module 622 may cause display module 602 to display a user notification that the potential edit is not permissible.

Customization module 624 is a software module adapted to enable a trajectory view to be customized. In an embodiment, customization module 624 may receive and maintain knowledge of user input commands relating to customization of a displayed trajectory. For example, the appearance of a displayed trajectory may be affected by a user's selection of various trajectory related display options, which selections may be indicated via manipulation of one or more of user interface devices 626 and conveyed to system 600 via user interface commands. For example, referring also to FIG. 2, user selection of trajectory related display options may be prompted, in an embodiment, by providing display icons such as reference icon 218, scale lateral icon 220, scale vertical icon 221, view three dimensional icon 222, view lateral icon 223, view vertical icon 224, and smooth icon 225, where the functionality of each of these icons was described above. Other methods for prompting user selection of trajectory related display options alternatively may be implemented, in other embodiments. Customization module 624 is adapted to maintain knowledge of user-specified display options, and to ensure that flight plan/path display commands that are provided to display module 602 conform to the user-specified display options.

As discussed previously, a new flight plan or requested modifications to an existing flight plan are not automatically committed to the flight plan data structure 630. In an embodiment, flight plan editor module 604 is adapted to store information describing newly generated flight plans and potential modifications to existing flight plans in non-persistent trajectory data structure 610. Upon receiving a user interface command that indicates a user's desire for a newly created flight plan and/or modifications to an existing flight plan to be incorporated into an actual flight plan that is implemented by FMS 620 (e.g., the user has selected the commit icon 228, FIG. 2), system 600 (e.g., concurrency update module 620) also may be adapted to send flight plan related requests to FMS 620 via an external entity interface 602. Such a request may convey information stored in non-persistent trajectory data structure 620 relating to a newly generated flight plan and/or modifications to an existing flight plan. According to various rules and strategies, FMS 620 may evaluate the requests and may determine whether or not to incorporate information reflected in the requests into a flight plan stored in flight plan data structure 630. In addition, FMS 620 may perform distance and bearing computations, trajectory optimization functions, and/or auto-generation of trajectory functions based on information within the requests. Once FMS 620 has incorporated information defining the newly-generated flight plans and/or modifications to existing flight plans into the flight plan data structure 630, a user may later cause the system 600 to access the flight plan data and to display a trajectory depiction of the flight plan during a flight and/or in the context of another flight plan editing session.

FIG. 7 is a flowchart of a method for defining and rendering a trajectory of an aircraft, according to an example embodiment. The method may include processes relating to defining a new flight plan, displaying a flight path and/or flight plan, and modifying an existing flight plan. The method may be executed, for example, by a flight plan processing system (e.g., flight plan processing system 600, FIG. 6). The flowchart of FIG. 7 is intended to depict only certain aspects of the inventive subject matter, and not to depict every process, variation, and/or embodiment previously discussed. It is to be understood that embodiments of methods for generating a flight plan, displaying a flight path and/or flight plan, and/or modifying a flight plan may include more, fewer or different processes than those depicted in FIG. 7, and/or the sequence of processes performed may be different from that depicted in FIG. 7. In addition, the sequence of processes depicted in FIG. 7 may be modified, in other embodiments, and/or certain ones of the processes may be entered as a result of receiving an interrupt or other triggering event. Accordingly, FIG. 7 and the below description are not intended to limit the scope of the inventive subject matter only to the illustrated and described embodiment.

The method may begin, in block 702, by entering the flight plan editing mode. Initially (e.g., upon boot up), the system may initialize to either the flight plan editing mode or the flight path/flight plan display mode. When the system initializes or currently is running in the flight path/flight plan display mode, a user may cause the system to enter the flight plan editing mode through manipulation of a user interface device (e.g., user interface device 626, FIG. 6). For example, a user may use a cursor control device (e.g., cursor control device 108, FIG. 1) to position a cursor (e.g., cursor 256, FIG. 2) over an edit mode icon (e.g., edit mode icon 227, FIG. 2). When the user depresses (e.g., “clicks”) the select button of the cursor control device, the system may initiate the process of entering the flight plan editing mode. Upon receiving an indication that the user desires the system to enter the flight plan editing mode, the system may begin loading and executing software associated with the flight plan editing mode (e.g., software associated with the display module 602 and the flight plan editor module 604, FIG. 6).

In block 704, the system may cause a three dimensional reference frame (e.g., reference frame 230, FIG. 2) to be rendered on a display device (e.g., display device 624, FIG. 6). In an embodiment, the three dimensional reference frame is rendered in a trajectory display area (e.g., trajectory display area 204, FIG. 2), and one or more additional icons (e.g., icons 212-228, FIG. 2) may be displayed along with the reference frame.

When a user desires to generate a new flight plan, no trajectory element indicators initially will be rendered in the reference frame, and the user may request the generation of new trajectory elements as will be described in more detail below. However, when the user desires to edit a flight plan that currently exists, the user may identify the flight plan through a user interface device (e.g., user interface device 626). For example, the system may provide one or more prompts that enable the user to identify a filename for an existing flight plan.

In block 706, the system may cause one or more trajectory element indicators (e.g., trajectory element indicators 240-254, FIG. 2) to be rendered by the display device. In an embodiment, the system may cause the trajectory element indicators to be rendered within a three dimensional reference frame in order to depict a trajectory of an aircraft in three dimensions, although a trajectory may be depicted in two dimensions as well. The trajectory element indicators that are rendered may correspond to trajectory elements for a flight plan that the user has indicated he or she would like the system to display. The system may receive the characteristics of the trajectory elements from an FMS (e.g., FMS 620, FIG. 6), which in turn, may retrieve the characteristics of the trajectory elements from a flight plan data structure (e.g., flight plan data structure 630, FIG. 6), in an embodiment. In addition or alternatively, the system may retrieve characteristics of one or more trajectory elements from a non-persistent trajectory data structure (e.g., non-persistent trajectory data structure 610, FIG. 6), which is adapted temporarily to store characteristics of trajectory elements that have not been committed to the flight plan data structure.

A collection of trajectory element indicators may correspond to a displayed trajectory (e.g., trajectory 238, FIG. 2). When a flight is in progress, trajectory element indicators corresponding to portions of the trajectory that have already been flown (e.g., the flight path) may be depicted in one manner, and trajectory element indicators corresponding to portions of the trajectory that have not yet been flown may be depicted in another manner. In addition, during a flight, an aircraft indicator (e.g., aircraft indictor 280, FIG. 2) may be displayed along the trajectory at a point that corresponds to a current position of the aircraft. As described previously, the system continuously may update the position of the displayed aircraft indicator as the flight progresses. As also described previously, the system may provide a user with an ability to modify various characteristics of the displayed trajectory.

Whether or not any trajectory elements previously have been defined for a flight plan, a user may indicate his or her desire to add a new trajectory element to a flight plan through manipulation of one or more user interface devices (e.g., user interface devices 626, FIG. 6). For example, a user may use a cursor control device (e.g., cursor control device 108, FIG. 1) to position a cursor (e.g., cursor 256, FIG. 2) at a point within the boundaries of the reference frame, and the user may depress a select button of the cursor control device to indicate his or her desire to add a new trajectory element. Alternatively, the system may add a plurality of new trajectory elements to a flight plan that is being defined in response to receiving one or more user interface commands that indicate a user selection of a pattern to be incorporated into the flight plan, as described previously. To edit the characteristics of an existing trajectory element, the user may use the cursor control device to position the cursor over the trajectory element, and may depress the select button to select the trajectory element. The user may then drag the selected trajectory element to a new position and drop the selected trajectory element at the new position, in an embodiment. In addition or alternatively, the user may use a touchscreen and/or a keyboard (e.g., keyboard 106, FIG. 1) to define or edit one or more characteristics of a new or selected trajectory element.

When a determination is made, in block 708, that a user has indicated his or her desire to add one or more new trajectory elements, or when a determination is made, in block 710, that a user has indicated his or her desire to edit one or more characteristics of an existing trajectory element, then a further determination may be made, in block 712, whether the new trajectory elements or the edit to the existing trajectory element is permissible. As described previously, information describing a requested new trajectory element or an edit to an existing trajectory element may be evaluated to determine whether one or more characteristics of the trajectory element fall outside of acceptable ranges or exceed thresholds. When a new trajectory element or the edit to the existing trajectory element is not permissible, then the system may cause a user notification to that effect to be displayed, in block 714, and the method may iterate as shown.

When a new trajectory element or the edit to the existing trajectory element is permissible, then the system may cause a trajectory element indicator corresponding to the new trajectory element or the edited trajectory element to be displayed, in block 716. The system also automatically may cause one or more additional trajectory elements to be displayed. For example, when a trajectory element corresponding to a new waypoint is added, the system also automatically may cause a trajectory element corresponding to a flight leg to be added between the new waypoint and a waypoint that precedes the new waypoint in the trajectory. In addition, the system may store the characteristics for the edited or new trajectory elements. For example, the characteristics may be stored in a non-persistent trajectory data structure (e.g., non-persistent trajectory data structure 610, FIG. 6).

A user may add and/or edit a plurality of trajectory elements in the manner described above. Eventually, the user may indicate his or her desire to commit a flight plan defined by the newly added or edited trajectory elements through manipulation of a user interface device (e.g., user interface device 626, FIG. 6). Commitment of a new flight plan or modifications to a flight plan may include storing the new flight plan or the modifications to a flight plan in a flight plan data structure (e.g., flight plan data structure 630, FIG. 6) for access by the FMS (e.g., FMS 620, FIG. 6) during flight. For example, a user may use a cursor control device (e.g., cursor control device 108, FIG. 1) to position a cursor (e.g., cursor 256, FIG. 2) over a commit icon (e.g., commit icon 228, FIG. 2). When the user depresses the select button of the cursor control device, the system may initiate the process of attempting to commit the new flight plan or the flight plan modifications to the flight plan data structure.

When a determination is made, in block 718, that the user has indicated his or her desire to commit a flight plan defined by the newly added or edited trajectory elements, then the system may send one or more flight plan related requests to the FMS (e.g., FMS 620, FIG. 6), in block 720. The flight plan related requests may include information describing characteristics of newly added and/or edited trajectory elements, for example. As described previously, the FMS may evaluate the requests according to various rules and strategies to determine whether or not to commit the newly added or edited trajectory elements by incorporating information reflected in the requests into a flight plan stored in the flight plan data structure (e.g., flight plan data structure 630, FIG. 6). When the FMS determines that the newly added or edited trajectory elements will be committed, the FMS may store the characteristics of the newly added or edited trajectory elements into the flight plan data structure (e.g., flight plan data structure 630, FIG. 6). Otherwise, the system may cause a user notification to be displayed that indicates, to the user, that the newly added or edited trajectory elements could not be committed.

At that time, and/or at any earlier time, a determination may be made whether the user has indicated his or her desire to exit the flight plan editing mode, in block 722. If not, then the method may iterate as shown. If so, then the system may exit the flight plan editing mode. When a flight currently is in progress, the system may transition to the flight path/flight plan display mode, in an embodiment. The method may then end.

Embodiments of systems and methods for flight planning have now been described. Systems and methods in accordance with various aspects of the embodiments may provide one or more advantages over traditional systems and methods. For example, an embodiment may provide an improved graphical user interface for entry and editing of flight plan related information in an aircraft environment. Some of the embodiments have been described in terms of functional block components and various processing steps. It should be appreciated that such functional blocks may be realized by any number of hardware, firmware, and/or software components configured to perform the specified functions. For example, the embodiments may employ various integrated circuit components (e.g., memory elements, digital signal processing elements, and so on) which may carry out a variety of functions under the control of one or more microprocessors or other control devices. Such general techniques and components that are known to those skilled in the art are not described in detail herein.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the embodiments in any way. Rather, the foregoing detailed description will provide those skilled in the art with a convenient road map for implementing an exemplary embodiment. It being understood that various changes may be made in the function and arrangement of elements described in an exemplary embodiment without departing from the scope of the inventive subject matter as set forth in the appended claims.

What is claimed is:

1. A system for defining and rendering a trajectory of an aircraft, the system comprising:
a processing system adapted to cause a three dimensional trajectory depiction to be rendered on a display device, wherein the three dimensional trajectory depiction includes at least one trajectory element indicator that corresponds to at least one trajectory element of a flight plan, and the processing system is further adapted to receive, from a user interface device, one or more user interface commands that indicate selection by a user of a selected trajectory element indicator and user-initiated movement of the selected trajectory element indicator from a first display position to a second display position, and wherein the processing system is further adapted to determine one or more modified characteristics of a trajectory element corresponding to the selected trajectory element indicator in response to the user-initiated movement, and to cause a modified trajectory depiction to be rendered, wherein the modified trajectory depiction includes the selected trajectory element indicator rendered at the second display position.

2. The system of claim 1, further comprising:
the user interface device, wherein the user interface device includes a cursor control device, and wherein a user interface command to the processing system that indicates user selection of the selected trajectory element indicator is generated in response to the user manipulating the cursor control device to cause a cursor rendered on the display device to be positioned in proximity to the selected trajectory element indicator and the user depressing a select button of the cursor control device while the cursor is positioned in proximity to the selected trajectory element.

3. The system of claim 2, wherein a user interface command to the processing system that indicates the user-initiated movement of the selected trajectory element indicator is generated in response to the user manipulating the cursor control device to drag the selected trajectory element indicator from the first display position to the second display position while the select button is depressed, and to drop the selected trajectory element at the second display position by releasing the select button.

4. The system of claim 1, further comprising:
the user interface device, wherein the user interface device includes a touchscreen, and wherein a user interface command that indicates user selection of the selected trajectory element indicator is generated in response to the user applying pressure to a portion of a display surface of the touchscreen at which the selected trajectory element indicator is rendered.

5. The system of claim 4, wherein a user interface command to the processing system that indicates the user-initiated movement of the selected trajectory element indicator is generated in response to the user continuously applying the pressure to the display surface between the first display position and the second display position, and removing the pressure at the second display position.

6. The system of claim 1, further comprising:
an interface with a flight management system, wherein the system is further adapted to send a flight plan related request to the flight management system through the interface, and wherein the flight plan related request includes information describing the one or more modified characteristics of the trajectory element.

7. The system of claim 6, further comprising:
the flight management system, wherein the flight management system is adapted to receive the flight plan related request, and to determine whether or not to incorporate the information included in the flight plan related request into a flight plan stored in a flight plan data structure.

8. The system of claim 6, further comprising:
the flight management system, wherein the processing system is further adapted to receive trajectory related information from the flight management system through the interface, and to render the three dimensional trajectory depiction based on the trajectory related information, wherein the trajectory related information includes information relating to a flight plan and information relating to a flight path.

9. A method for defining and rendering a trajectory of an aircraft, the method comprising the steps of:
causing a three dimensional trajectory depiction to be rendered on a display device, wherein the three dimensional trajectory depiction includes one or more trajectory element indicators that correspond to one or more trajectory elements of a flight plan;
receiving one or more user input commands from a user interface device, wherein the one or more user input commands indicate selection by a user of a selected trajectory element indicator of the one or more trajectory element indicators, and a user-initiated movement of the selected trajectory element indicator from a first display position to a second display position;
determining one or more modified characteristics of a trajectory element corresponding to the selected trajectory element indicator in response to the user-initiated movement; and
causing a modified trajectory depiction to be rendered on the display device, wherein the modified trajectory depiction includes the selected trajectory element indicator rendered at the second display position.

10. The method of claim 9, further comprising:
causing a three dimensional reference frame to be displayed on the display device, wherein the three dimensional trajectory depiction is rendered in an area defined by the three dimensional reference frame.

11. The method of claim 9, further comprising:
causing one or more additional icons to displayed on the display device, wherein the one or more additional icons include one or more icons selected from a group of icons that includes a view three dimensional icon, a view lateral icon, and a view vertical icon.

12. The method of claim 9, wherein the one or more trajectory element indicators include one or more waypoint indicators and one or more flight leg indicators, the method further comprising:
calculating a smoothed trajectory based on maneuverability constraints of the aircraft, wherein the smoothed trajectory includes one or more curved flight leg indicators between one or more waypoint indicators,
and wherein causing the three dimensional trajectory depiction to be displayed includes causing the smoothed trajectory to be displayed.

13. The method of claim 9, further comprising:
receiving one or more user interface commands indicating a user selection of a trajectory pattern to be incorporated into the flight plan; and
adding a plurality of new trajectory elements to the flight plan, wherein the plurality of new trajectory elements correspond to the trajectory pattern.

14. The method of claim 13, wherein the pattern includes a pattern selected from a group of trajectory patterns that includes a straight line pattern, a curved line pattern, a holding pattern, an orbit pattern, a procedure turn pattern, a spiral pattern with varying altitude and/or radius, and a convolute pattern.

15. The method of claim 9, further comprising:
receiving trajectory related information from a flight management system, wherein causing the three dimensional trajectory depiction to be rendered is performed according to the trajectory related information;
sending a flight plan related request to a flight management system, wherein the flight plan related request includes information describing the one or more modified characteristics of the trajectory element; and
the flight management system determining whether or not to incorporate the information included in the flight plan related request into the flight plan.

16. The method of claim 15, further comprising:
when the flight management system determines to incorporate the information included in the flight plan related request into the flight plan, the flight management system incorporating the information included in the flight plan related request into the flight plan stored in a flight plan data structure.

17. The method of claim 9, wherein the user interface device includes a cursor control device, and wherein a user interface command indicating the selection by the user of the selected trajectory element indicator is generated in response to the user manipulating the cursor control device to cause a cursor rendered on the display device to be positioned in proximity to the selected trajectory element indicator and the user depressing a select button of the cursor control device while the cursor is positioned in proximity to the selected trajectory element.

18. The method of claim 17, wherein a user interface command indicating the user-initiated movement of the selected trajectory element indicator is generated in response to the user manipulating the cursor control device to drag the selected trajectory element indicator from the first display position to the second display position while the select button is depressed, and to drop the selected trajectory element at the second display position by releasing the select button.

19. The method of claim 9, wherein the user interface device includes a touchscreen, and wherein a user interface command indicating the selection by the user of the selected trajectory element indicator is generated in response to the user applying pressure to a portion of a display surface of the touchscreen at which the selected trajectory element indicator is rendered.

20. The method of claim 20, wherein a user interface command indicating the user-initiated movement of the selected trajectory element indicator is generated in response to the user continuously applying the pressure to the display surface between the first display position and the second display position, and removing the pressure at the second display position.
